(19) United States
(12) Patent Application Publication
(10) Pub. No.: US 2018/0183018 A1
(43) Pub. Date: Jun. 28, 2018

(54) ENERGY STORAGE DEVICE

(71) Applicant: GS Yuasa International Ltd., Kyoto-shi (JP)

(72) Inventors: Kazuto MAEDA, Kyoto-shi (JP); Hirokazu KAMBAYASHI, Kyoto-shi (JP)

(21) Appl. No.: 15/852,383

(22) Filed: Dec. 22, 2017

(30) Foreign Application Priority Data
Dec. 26, 2016 (JP) 2016-251226
Nov. 20, 2017 (JP) 2017-223120

(51) Int. Cl. H01M 2/08; H01M 2/02; H01M 2/06; H01M 10/0587

(52) U.S. Cl. CPC H01M 2/08; H01M 10/0587; H01M 2/06; H01M 2/0202

(57) ABSTRACT

An energy storage device includes: an electrode assembly; a container that includes a wall portion and accommodates the electrode assembly; a first conductive member; a second conductive member electrically connected to the electrode assembly and connected to the first conductive member and is arranged to pass through the wall portion; and a sealing member that is nonmetallic and disposed between the first conductive member and the second conductive member. The first conductive member and the second conductive member are in direct contact and are made of mutually different metal materials. The sealing member is disposed at a contact interface of the first conductive member and the second conductive member.

### CROSS-REFERENCE TO RELATED APPLICATIONS

This application claims the benefit of Japanese patent applications No. 2016-251226 filed on Dec. 26, 2016, and No. 2017-223120 filed on Nov. 20, 2017, which are incorporated by reference.

### FIELD

The present invention relates to an energy storage device including a conductive member that is electrically connected to an electrode assembly.

### BACKGROUND

In some energy storage devices such as a lithium ion secondary battery, an electrode assembly including positive and negative electrodes is connected to an electrode terminal via a conductive member (also referred to as a current collecting member). For example, JP 2015-141896 A discloses a secondary battery provided with, as a conductive member, a current collecting member that electrically connects an electrode assembly to an electrode terminal. The current collecting member and the electrode terminal are made of mutually different materials. Further, a seal molding is provided so as to cover a coupling portion between the current collecting member and the electrode terminal.

In the secondary battery disclosed in JP 2015-141896 A, the current collecting member and the electrode terminal constitute an electrode unit, and the electrode unit passes through a cap plate of a casing of the electrode assembly. The seal molding is provided to be interposed between the electrode unit and the cap plate. The seal molding is formed by a molding resin, and specifically formed by insert injection molding. Such a seal molding suppresses corrosion (also referred to as galvanic corrosion) at an interface of dissimilar metals, by covering and protecting a coupling portion including the interface between dissimilar metals, and blocking permeation of moisture. However, each time there is a change in a shape or size (design change) of the current collecting member, the electrode terminal, the coupling portion between the current collecting member and the electrode terminal, the cap plate, and the like, a metal mold for molding the seal molding is required to be changed to have a shape and size corresponding to the above. This increases cost.

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

An object of the present invention is to provide an energy storage device that reduces cost for suppressing corrosion between dissimilar metals.

An energy storage device according to an aspect of the present invention includes: an electrode assembly; a container that includes a wall portion and accommodates the electrode assembly; a first conductive member; a second conductive member electrically connected to the electrode assembly and connected to the first conductive member, and the second conductive member being arranged to pass through the wall portion; and a sealing member that is nonmetallic and disposed between the first conductive member and the second conductive member. In the energy storage device, the first conductive member and the second conductive member are in direct contact; the first conductive member and the second conductive member are made of mutually different metal materials; and the sealing member is disposed at a contact interface of the first conductive member and the second conductive member.

### BRIEF DESCRIPTION OF DRAWINGS

The foregoing and other features of the present invention will become apparent from the following description and drawings of an illustrative embodiment of the invention in which:

FIG. 1 is a perspective view schematically illustrating an appearance of an energy storage device according to an embodiment.

FIG. 2 is a partially exploded perspective view of the energy storage device of FIG. 1.

FIG. 3 is an exploded perspective view of a positive electrode terminal, a negative electrode terminal, and their peripheral constitutional elements in FIG. 2.

FIG. 4 is an exploded perspective view of the negative electrode terminal and its peripheral constitutional elements in FIG. 3, as enlarged and viewed from a similar direction to FIG. 3.

FIG. 5A is a cross-sectional side view of a cross section across the positive electrode terminal and the negative electrode terminal of the energy storage device of FIG. 1 as viewed in a direction V, and is a view illustrating a configuration of the negative electrode terminal and its periphery.

FIG. 5B is a cross-sectional side view enlarging FIG. 5A, and is a view illustrating a casing with a sealing member removed.

FIG. 6 is a cross-sectional side view illustrating, similarly to FIG. 5A, a configuration of a negative electrode terminal and its periphery in an energy storage device according to Modification 1.

FIG. 7 is a cross-sectional side view illustrating, similarly to FIG. 5A, a configuration of a negative electrode terminal and its periphery in an energy storage device according to Modification 2.

FIG. 8 is a cross-sectional side view illustrating, similarly to FIG. 5A, a configuration of a negative electrode terminal and its periphery in an energy storage device according to Modification 3.

FIG. 9 is a cross-sectional side view illustrating, similarly to FIG. 5A, a configuration of the negative electrode terminal and its periphery in the energy storage device according to another aspect of Modification 3.

FIG. 10 is a cross-sectional side view illustrating, similarly to FIG. 5A, a configuration of a negative electrode terminal and its periphery in an energy storage device according to Modification 4.

FIG. 11 is a cross-sectional side view illustrating, similarly to FIG. 5A, a configuration of the negative electrode terminal and its periphery in the energy storage device according to another aspect of Modification 4.

FIG. 12 is a cross-sectional side view illustrating, similarly to FIG. 5A, a configuration of the negative electrode terminal and its periphery in the energy storage device according to another aspect of Modification 4.

FIG. 13 is a cross-sectional side view illustrating, similarly to FIG. 5A, a configuration of the negative electrode terminal and its periphery in the energy storage device according to another aspect of Modification 4.

FIG. 14 is a cross-sectional side view illustrating, in a similar cross section to that in FIG. 5A, a configuration of a negative electrode terminal and sealing member in an energy storage device according to Modification 5.

FIG. 15 is a cross-sectional side view illustrating, similarly to FIG. 10, a configuration of a negative electrode terminal and sealing member in an energy storage device according to Modification 6.

### DESCRIPTION OF EMBODIMENTS

An energy storage device according to an aspect of the present invention includes: an electrode assembly; a container that includes a wall portion and accommodates the electrode assembly; a first conductive member; a second conductive member electrically connected to the electrode assembly and connected to the first conductive member, and the second conductive member being arranged to pass through the wall portion; and a sealing member that is nonmetallic and disposed between the first conductive member and the second conductive member. In the energy storage device, the first conductive member and the second conductive member are in direct contact; the first conductive member and the second conductive member are made of mutually different metal materials; and the sealing member is disposed at a contact interface of the first conductive member and the second conductive member.

The sealing member may be disposed at an end portion of the contact interface of the first conductive member and the second conductive member.

The second conductive member may include a shaft portion passing through the wall portion, and a fixing portion that fixes the shaft portion to the wall portion.

The second conductive member may include a plastic strain part at an end of the shaft portion. The fixing portion may be constituted by the plastic strain part.

The sealing member may include a first sealing member disposed at a portion where the first conductive member and the fixing portion are adjacent in an axial direction of the shaft portion.

The sealing member may include a second sealing member disposed at a portion where the first conductive member and the shaft portion are adjacent.

The fixing portion may more protrude than the first conductive member in the axial direction of the shaft portion.

The fixing portion may be positioned to be more depressed than the first conductive member in the axial direction of the shaft portion.

Hardness of the sealing member may be lower than hardness of the first conductive member and hardness of the second conductive member.

The sealing member may include a convex part protruding toward at least one of the first conductive member and the second conductive member.

At least one of the first conductive member and the second conductive member may include a convex part protruding toward the sealing member.

The energy storage device according to the present invention enables reduction of cost for suppressing corrosion between dissimilar metals.

Hereinafter, an energy storage device according to an embodiment and modifications of the present invention will be described with reference to the drawings. Note that each of all the embodiment and modifications described below illustrates one preferred specific example of the present invention. Each of numerical values, shapes, materials, constitutional elements, arrangement positions and connection forms of constitutional elements, and the like illustrated in the following embodiment and modifications is an example and is not intended to limit the present invention. In addition, among constitutional elements in the following embodiment and modifications, the constitutional elements not described in independent claims illustrating an uppermost concept are described as arbitrary constitutional elements.

Further, each figure in the accompanying drawings is a schematic view, and is not necessarily illustrated in a precise manner. Further, in each figure, identical or similar constitutional elements are denoted by same reference numerals. In addition, in the following description of the embodiment, there may be used an expression with “substantially”, such as substantially parallel and substantially orthogonal. For example, substantially parallel also means, in addition to a state of being perfectly parallel, a state of being substantially parallel, that is, a state including a difference of a few percent, for example. This similarly applies to other expressions with “substantially”.

### Embodiment

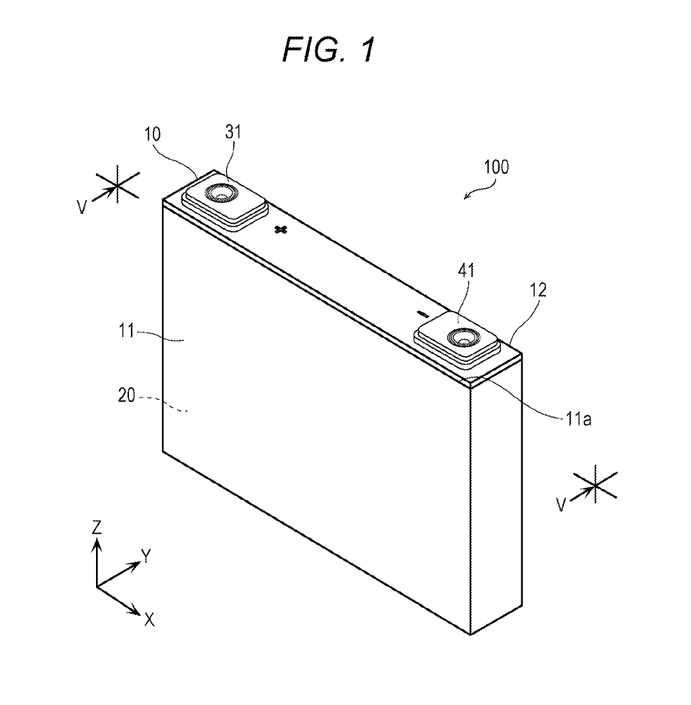

A configuration of an energy storage device 100 according to the embodiment will be described. FIG. 1 is a perspective view schematically illustrating an appearance of the energy storage device 100 according to the embodiment. As illustrated in FIG. 1, the energy storage device 100 has a flat rectangular parallelepiped outer shape. The energy storage device 100 is a secondary battery capable of charge-discharge. For example, the energy storage device 100 is a nonaqueous electrolyte secondary battery such as a lithium ion secondary battery. However, the energy storage device 100 is not limited to the nonaqueous electrolyte secondary battery, and may be a secondary battery other than the nonaqueous electrolyte secondary battery. The energy storage device 100 may also be a primary battery capable of using stored electricity even without being charged by a user, and may also be a capacitor.

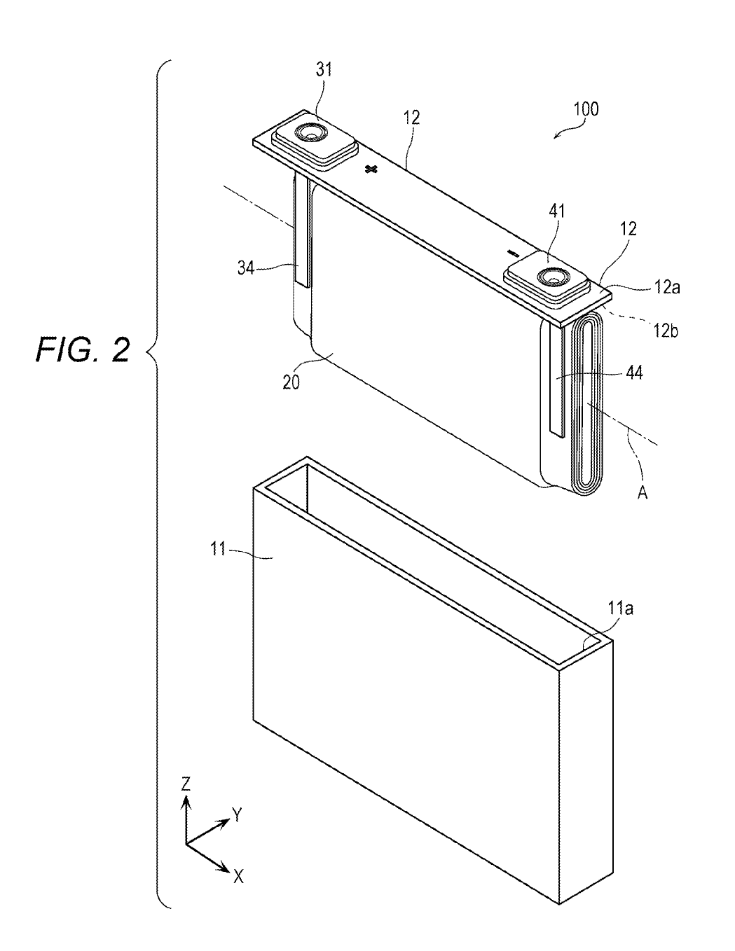

FIG. 2 is a partially exploded perspective view of the energy storage device 100 of FIG. 1. Referring to FIGS. 1 and 2, the energy storage device 100 includes a container 10 having a flat rectangular parallelepiped shape, an electrode assembly 20 accommodated in the container 10, and a positive electrode terminal 31 and a negative electrode terminal 41 as electrode terminals. The positive electrode terminal 31 and the negative electrode terminal 41 are provided to be exposed to an external space of the container 10. The negative electrode terminal 41 as used herein is an example of a first conductive member.

The container 10 includes a container body 11 having a shape of bottomed rectangular tube, and a lid body 12 having an elongated rectangular plate shape and being capable of closing an elongated rectangular opening 11a of the container body 11. The container body 11 and the lid body 12 are fixed to each other by a joining method such as welding. The container body 11 and the lid body 12 can be made of, but not limited to, a weldable metal such as stainless steel, aluminum, or aluminum alloy, for example. The lid body 12 as used herein is an example of a wall portion of the container.

The lid body 12 includes an outer surface 12a and an inner surface 12b that are rectangular and opposed to each other. A direction along a longitudinal direction of a rectangle formed by the lid body 12 and along the outer surface 12a and the inner surface 12b is defined as an X-axis direction. A direction perpendicular to the longitudinal direction of the lid body 12 and along the outer surface 12a and the inner surface 12b is defined as a Y-axis direction. A direction perpendicular to the outer surface 12a and the inner surface 12b is defined as a Z-axis direction. The X-axis direction, the Y-axis direction, and the Z-axis direction are orthogonal to each other.

Together with the electrode assembly 20, an electrolyte such as an electrolyte solution (nonaqueous electrolyte solution in the present embodiment) is sealed in the container 10, but illustration of the electrolyte is omitted. A type of the electrolyte sealed in the container 10 is not particularly limited as long as it does not impair performance of the energy storage device 100, and various electrolytes can be selected.

On the outer surface 12a of the lid body 12, there are disposed the positive electrode terminal 31 and the negative electrode terminal 41 that have electrical conductivity. The positive electrode terminal 31 is disposed near one of two end portions in the X-axis direction of the lid body 12, and the negative electrode terminal 41 is disposed near the other of the two end portions in the X-axis direction of the lid body 12. The positive electrode terminal 31 and the negative electrode terminal 41 are physically and electrically connected respectively to a positive-electrode current collecting member 34 and a negative-electrode current collecting member 44 that have electrical conductivity and are disposed on opposite sides with the lid body 12 interposed therebetween. The positive-electrode current collecting member 34 and the negative-electrode current collecting member 44 are also physically and electrically connected to the electrode assembly 20. The positive-electrode current collecting member 34 and the negative-electrode current collecting member 44 are accommodated in the container body 11 together with the electrode assembly 20. The negative-electrode current collecting member 44 as used herein is an example of a second conductive member.

The electrode assembly 20 is an energy storage element (also referred to as a power generating element) capable of storing electricity. The electrode assembly 20 is formed by spirally winding a positive electrode plate (not shown) having a sheet shape, a negative electrode plate (not shown) having a sheet shape, and a separator (not shown) having a sheet shape, all together, around a winding axis A. This causes the positive electrode plate and the negative electrode plate to be stacked in multiple layers around a winding axis A, while interposing the separator therebetween. The winding axis A is an imaginary axis indicated by a dashed line in FIG. 2, and the electrode assembly 20 has a configuration that is substantially symmetrical with respect to the winding axis A. In the present embodiment, the electrode assembly 20 has, but not limited to, a flat outer shape having an oval cross section perpendicular to the winding axis A. The electrode assembly 20 includes, around the winding axis A, two curved portions, and a flat portion between the curved portions. However, the cross-sectional shape of the electrode assembly 20 may also be other than an oval shape, and may be a circular shape, an elliptical shape, a rectangular shape, or other polygonal shape or the like.

The positive electrode plate includes a positive electrode substrate (not shown), which is a belt-shaped metal foil made of a metal such as aluminum or an aluminum alloy. A positive active material layer (not shown) formed on the positive electrode substrate. The negative electrode plate includes a negative electrode substrate (not shown), which is a belt-shaped metal foil made of a metal such as copper or copper alloy. A negative active material layer (not shown) formed on the negative electrode substrate. As the positive active material and the negative active material respectively used for the positive active material layer and the negative active material layer, any known material can be appropriately used as long as being a positive active material and a negative active material capable of occlusion and release of lithium ions. The separator is a sheet made of an electrically insulating material such as a resin, and is a microporous sheet, for example.

The positive electrode plate at one end portion of the electrode assembly 20 in a winding axis A direction is connected to the positive-electrode current collecting member 34, while the negative electrode plate at the other end portion is connected to the negative-electrode current collecting member 44. Here, the electrode assembly 20 is disposed with respect to the lid body 12 such that the winding axis A is oriented along the X-axis direction, which is the longitudinal direction of the lid body 12, and one of the curved portions is opposed to the lid body 12.

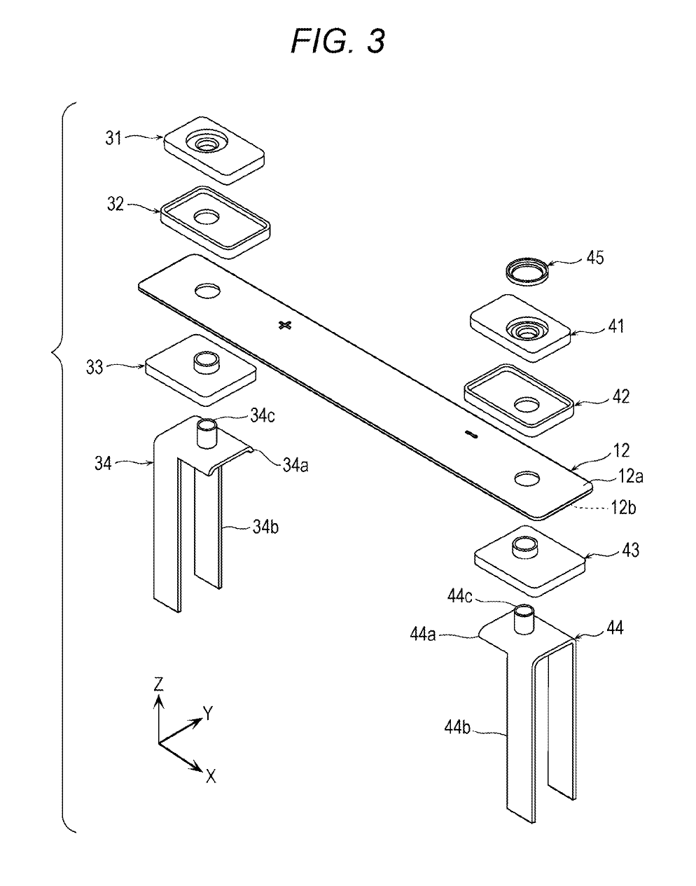

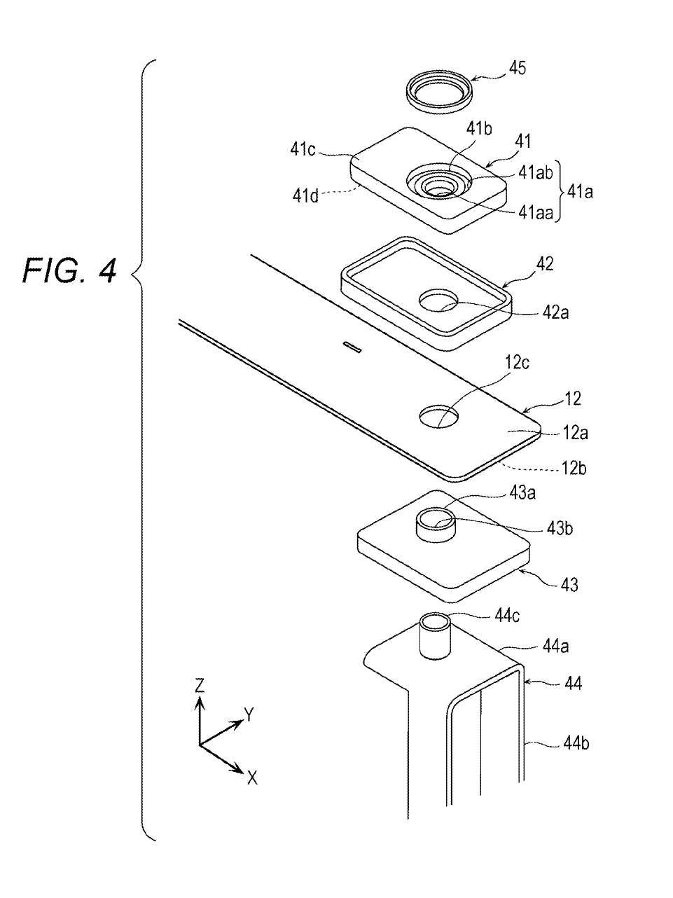

With reference to FIGS. 3 and 4, a configuration of the positive electrode terminal 31, the negative electrode terminal 41, and their periphery will be described. FIG. 3 is an exploded perspective view of the positive electrode terminal 31 and the negative electrode terminal 41 and their peripheral constitutional elements in FIG. 2. FIG. 4 is an exploded perspective view of the negative electrode terminal 41 and its peripheral constitutional elements in FIG. 3, as enlarged and viewed from a similar direction to FIG. 3. The positive electrode terminal 31 and the negative electrode terminal 41 each are made of a material having conductivity, and have a similar configuration except that a sealing member 45 (described later) is disposed at the negative electrode terminal 41. Therefore, the configuration related to the negative electrode terminal 41 will be described in detail below, and a detailed description of the configuration related to the positive electrode terminal 31 will be omitted.

The positive electrode terminal 31 and the negative electrode terminal 41 have a rectangular plate shape. In the present embodiment, the positive electrode terminal 31 and the negative electrode terminal 41 are made of, but not limited to, a similar metal material to that of the positive electrode substrate of the electrode assembly 20. The positive electrode terminal 31 and the negative electrode terminal 41 may also be made of a material other than the above-mentioned metals, or may be made of mutually different materials.

Upper insulating members 32 and 42 and lower insulating members 33 and 43 are provided for electrically insulating the positive and negative electrode terminals 31 and 41 from the lid body 12, and for electrically insulating the lid body 12 from the positive and negative-electrode current collecting members 34 and 44. The upper insulating members 32 and 42 and the lower insulating members 33 and 43 have a rectangular plate shape, and are made of an electrically insulating material such as a resin, and are gaskets, for example. The upper insulating members 32 and 42 and the lower insulating members 33 and 43 may be made of an inorganic insulating material such as mica, ceramic, or glass, rather than an organic insulating material such as a resin, as long as having electrical insulation.

In the present embodiment, the positive-electrode current collecting member 34 and the negative-electrode current collecting member 44 are made of, but not limited to, a similar metal material to that of the positive electrode substrate and the negative electrode substrate of the electrode assembly 20. At least one of the positive-electrode current collecting member 34 and the negative-electrode current collecting member 44 is made of a different metal material from that of the positive electrode terminal 31 and the negative electrode terminal 41 to which they are connected. In the present embodiment, an example is described in which the negative-electrode current collecting member 44 alone is made of a metal material different from that of the negative electrode terminal 41, and the positive-electrode current collecting member 34 is made of an identical metal material to that of the positive electrode terminal 31, but the present invention is not limited to this.

The positive-electrode current collecting member 34 and the negative-electrode current collecting member 44 respectively have: one base 34a having a rectangular plate shape and one base 44a having a rectangular plate shape; two leg portions 34b and two leg portions 44b respectively extending from the bases 34a and 44a in a direction substantially perpendicular to the bases 34a and 44a; and shaft portions 34c and 44c having a cylindrical shape and extending from the bases 34a and 44a in a direction substantially perpendicular to the bases 34a and 44a. The leg portions 34b and 44b and the shaft portions 34c and 44c extend in directions opposite to each other. All of the base, the leg portions, and the shaft portion may be integrally formed by integral molding or the like, or at least one of them may be a separate member. The leg portions 34b and 44b are connected to the electrode assembly 20.

The positive electrode terminal 31, the upper insulating member 32, the lid body 12, the lower insulating member 33, and the base 34a of the positive-electrode current collecting member 34 are arranged to be stacked in this order. The shaft portion 34c of the positive-electrode current collecting member 34 sequentially passes through the lower insulating member 33, the lid body 12, the upper insulating member 32, and the positive electrode terminal 31, and is joined to the positive electrode terminal 31. The negative electrode terminal 41, the upper insulating member 42, the lid body 12, the lower insulating member 43, and the base 44a of the negative-electrode current collecting member 44 are arranged to be stacked in this order. The shaft portion 44c of the negative-electrode current collecting member 44 sequentially passes through the lower insulating member 43, the lid body 12, the upper insulating member 42, and the negative electrode terminal 41, and is joined to the negative electrode terminal 41. As a result, the positive electrode terminal 31, the upper insulating member 32, the lower insulating member 33, and the positive-electrode current collecting member 34 are fixed to the lid body 12, while the negative electrode terminal 41, the upper insulating member 42, the lower insulating member 43, and the negative-electrode current collecting member 44 are fixed to the lid body 12. Furthermore, the positive electrode terminal 31 and the positive-electrode current collecting member 34 are physically and electrically connected to each other, while the negative electrode terminal 41 and the negative-electrode current collecting member 44 are physically and electrically connected to each other.

In the present embodiment, the shaft portions 34c and 44c are respectively joined to the positive electrode terminal 31 and the negative electrode terminal 41 by swage joining. In the swage joining, tip portions of the shaft portions 34c and 44c respectively projecting from the positive electrode terminal 31 and the negative electrode terminal 41 receive a pressure applied toward the lid body 12, thereby to be plastically strained so as to expand in a circular shape radially outward to form swaged projecting portions. The swaged projecting portions hold the positive electrode terminal 31 and the negative electrode terminal 41, and fix them to the lid body 12. The swaged projecting portions may be formed by a spin swaging method, for example, by pressurizing the tip portions of the shaft portions 34c and 44c with a rotating jig, and deforming the tip portions in radially outward direction. In addition, the swaged projecting portions may be formed by a press swaging method in which the tip portions of the shaft portions 34c and 44c are pressed and crushed. The shaft portions 34c and 44c may be solid cylinders. The shaft portions 34c and 44c may be connected with the positive electrode terminal 31 and the negative electrode terminal 41 by a joining method other than swaging. For example, joining by screw fastening using a screw or the like may be used.

As will be described in detail later, a through hole of the negative electrode terminal 41 through which the shaft portion 44c passes is enlarged in diameter in a stepped shape in a middle in the axial direction thereof. Specifically, a diameter of a large diameter portion on a side opposite to the upper insulating member 42 in the through hole is larger than a diameter of a small diameter portion adjacent to the upper insulating member 42, in the through hole. On the large diameter portion of the negative electrode terminal 41, the sealing member 45 having an annular shape is disposed. The sealing member 45 has a shape and dimension surrounding a periphery of the small diameter portion of the negative electrode terminal 41, and is sandwiched between the swaged projecting portion of the shaft portion 44c and the negative electrode terminal 41.

The sealing member 45 is a member having liquid tightness to inhibit intrusion of liquid from outside into between the swaged projecting portion of the shaft portion 44c and the negative electrode terminal 41. In the present embodiment, the swaged projecting portion of the shaft portion 44c and the negative electrode terminal 41 are made of metal materials having mutually different ionization tendencies. If the swaged projecting portion of the shaft portion 44c and the negative electrode terminal 41 are conducted through liquid (moisture or the like), galvanic corrosion may occur. The sealing member 45 suppresses occurrence of galvanic corrosion. It is to be noted that the sealing member may be or may not be provided between the swaged projecting portion of the shaft portion 34c of the positive-electrode current collecting member 34 and the positive electrode terminal 31 that are made of an identical metal material to each other.

In the present embodiment, the sealing member 45 is made of a nonmetallic material. Further, the sealing member 45 preferably has hardness lower than that of the shaft portion 44c and the negative electrode terminal 41 that are to be sealed. Here, the sealing member 45 is sandwiched between and pressed by two constitutional elements to be sealed, so that the sealing member 45 is deformed corresponding to a shape of a contact surface of the constitutional elements, to effectively seal between these constitutional elements. The hardness can be determined using an index of hardness such as Vickers hardness, Brinell hardness, and Rockwell hardness. Vickers hardness, Brinell hardness, and Rockwell hardness all indicate indentation hardness near a surface of a measurement object.

The sealing member 45 as described above may be made of an electrically insulating material, such as a resin having hardness lower than that of the shaft portion 44c and the negative electrode terminal 41. As the resin for forming the sealing member 45, for example, there may be used polyphenylene sulfide (PPS), polyether ether ketone (PEEK), polypropylene (PP), tetrafluoroethylene-perfluoroalkyl vinyl ether copolymer (PFA), or the like. Further, the sealing member 45 may be made of a resin containing a filler such as a particulate, fibrous, or plate-shaped filler. Various known substances such as carbon and metal oxide may be used as the constituent material of the filler. It is to be noted that the sealing member 45 in direct contact with the swaged projecting portion of the shaft portion 44c and the negative electrode terminal 41 is, for cutting off the electrical connection therebetween, desirably made of an electrically insulating material.

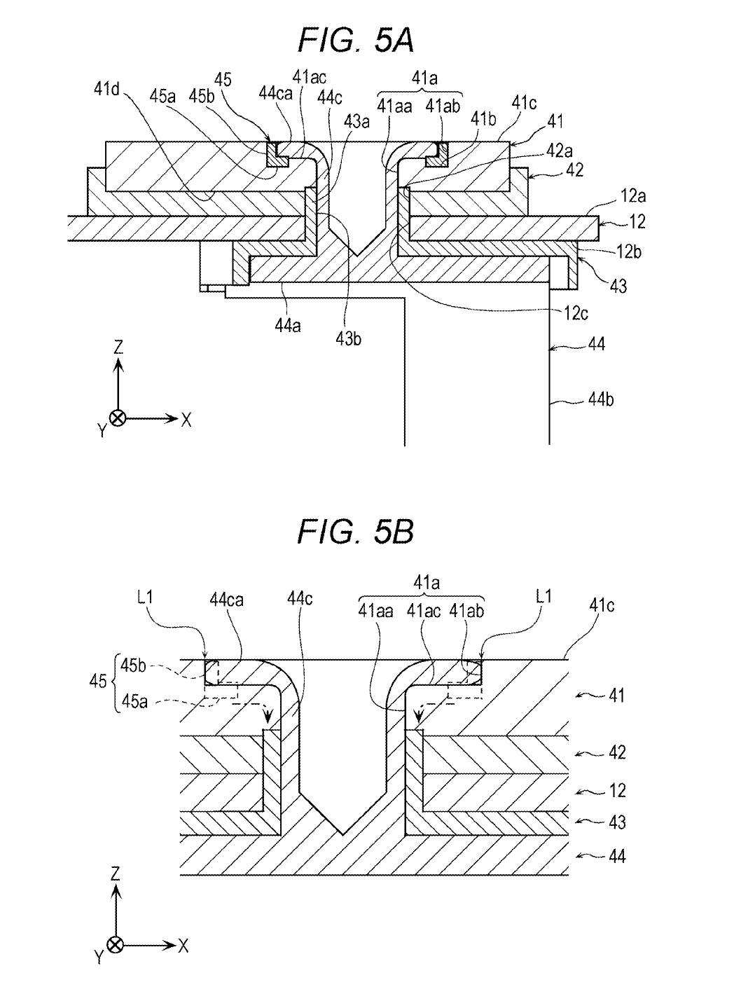

With reference to FIGS. 4 and 5A, details of a configuration of the negative electrode terminal 41, the sealing member 45, and their periphery will be described. FIG. 5A is a cross-sectional side view illustrating a cross section along the XZ plane and across the positive electrode terminal 31 and the negative electrode terminal 41 of the energy storage device 100 of FIG. 1 as viewed in a direction V in the Y-axis direction, and is a view illustrating a configuration of the negative electrode terminal 41 and its periphery.

In the negative electrode terminal 41, a through hole 41a is formed. The through hole 41a is enlarged in diameter in a middle in its axial direction, and includes a small diameter portion 41aa and a large diameter portion 41ab having an inner diameter larger than that of the small diameter portion 41aa. The large diameter portion 41ab opens at a surface 41c of the negative electrode terminal 41 on a side opposite to the upper insulating member 42, while the small diameter portion 41aa opens at a surface 41d opposite to the surface 41c and adjacent to the upper insulating member 42. The small diameter portion 41aa has an inner diameter equal to an outer diameter of the shaft portion 44c of the negative-electrode current collecting member 44. On a stepped portion 41ac having an annular shape between the large diameter portion 41ab and the small diameter portion 41aa, there is formed a groove 41b having an annular shape and surrounding a periphery of the opening of the small diameter portion 41aa. The groove 41b has a rectangular cross-sectional shape and is positioned adjacent to an inner peripheral surface of the large diameter portion 41ab.

In the groove 41b, the sealing member 45 having an annular shape is disposed. The sealing member 45 has an L-shaped cross-sectional shape in a radial direction. The sealing member 45 integrally includes a side wall portion 45b having a cylindrical shape, and a bottom wall portion 45a which is an annular plate shape and extends radially inward from an edge of the side wall portion 45b, along the edge. The bottom wall portion 45a abuts against the bottom surface of the groove 41b in the Z-axis direction, while the side wall portion 45b abuts against the inner peripheral surface of the large diameter portion 41ab. This causes the sealing member 45 to be fitted and positioned in the groove 41b. The bottom wall portion 45a has a thickness larger than the depth of the groove 41b in the Z-axis direction, and is more protruded than the stepped portion 41ac. The sealing member 45 is disposed at a corner portion between the stepped portion 41ac and the large diameter portion 41ab.

The lower insulating member 43 integrally includes a tubular portion 43a protruding and extending in the Z-axis direction. In the lower insulating member 43, a through hole 43b is formed through the tubular portion 43a to pass through the lower insulating member 43. The lower insulating member 43 is assembled to the lid body 12 and the upper insulating member 42, with the tubular portion 43a passing through a through hole 12c formed in the lid body 12 and a through hole 42a formed in the upper insulating member 42. A tip end of the tubular portion 43a is fitted into an annular groove that is formed so as to surround a periphery of the small diameter portion 41aa on the surface 41d of the negative electrode terminal 41. This allows the tubular portion 43a to suppress intrusion of liquid into the small diameter portion 41aa, from between the surface 41d of the negative electrode terminal 41 and the upper insulating member 42.

The shaft portion 44c of the negative-electrode current collecting member 44 is sequentially passed through the through hole 43b of the tubular portion 43a of the lower insulating member 43, and the through hole 41a of the negative electrode terminal 41. The shaft portion 44c is subjected to swaging processing for joining at the tip portion of the shaft portion 44c protruding to the large diameter portion 41ab of the through hole 41a. In the swaging processing, a pressure in the Z-axis direction is applied to the tip portion of the shaft portion 44c. This causes plastic strain of the tip portion so as to enlarge its diameter in a radial direction of the large diameter portion 41ab, to form a swaged projecting portion 44ca. The formed swaged projecting portion 44ca extends to expand in a circular shape on the stepped portion 41ac, and reaches the sealing member 45. The swaged projecting portion 44ca presses the bottom wall portion 45a against a bottom portion of the groove 41b, that is, the negative electrode terminal 41. Further, the swaged projecting portion 44ca abuts against the side wall portion 45b of the sealing member 45 by enlarging its diameter, and presses the side wall portion 45b against the inner peripheral surface of the large diameter portion 41ab. In addition, the swaged projecting portion 44ca is in direct contact with the stepped portion 41ac, that is, the negative electrode terminal 41, on an inner side of the sealing member 45. The swaged projecting portion 44ca as used herein is an example of a fixing portion and a plastic strain part.

Here, the bottom wall portion 45a of the sealing member 45 is positioned at a portion where the negative electrode terminal 41 and the swaged projecting portion 44ca are adjacent in an axial direction of the shaft portion 44c. The side wall portion 45b is positioned at a portion where the negative electrode terminal 41 and the swaged projecting portion 44ca are adjacent in a radial direction of the shaft portion 44c. Then, the swaged projecting portion 44ca maintains the strained shape in a state where the bottom wall portion 45a and the side wall portion 45b of the sealing member 45 are respectively pressed against the bottom portion of the groove 41b and the inner peripheral surface of the large diameter portion 41ab. The sealing member 45 is in direct contact with the swaged projecting portion 44ca and the negative electrode terminal 41 near the surface 41c. The sealing member 45 liquid-tightly seals a gap (contact interface) between the swaged projecting portion 44ca and the negative electrode terminal 41, at the corner portion between the stepped portion 41ac and the large diameter portion 41ab. In particular, the bottom wall portion 45a, which receives the pressure applied at a time of swage joining, effectively seals between the bottom wall portion 45a and the swaged projecting portion 44ca, and between the bottom wall portion 45a and the negative electrode terminal 41.

The bottom wall portion 45a more protrudes than the stepped portion 41ac extends so as to externally cover an outer peripheral edge of a contact interface between the swaged projecting portion 44ca and the stepped portion 41ac in the Z-axis direction. Therefore, the sealing member 45 more securely suppresses intrusion of liquid flowing from outside to the gap between the swaged projecting portion 44ca and the inner peripheral surface of the large diameter portion 41ab, into the contact interface of the swaged projecting portion 44ca and the stepped portion 41ac.

Further, the side wall portion 45b of the sealing member 45 extending substantially perpendicular to the stepped portion 41ac suppresses conduction between the swaged projecting portion 44ca and the negative electrode terminal 41 caused by liquid flowing into the gap between the swaged projecting portion 44ca and the inner peripheral surface of the large diameter portion 41ab. Examples of the liquid above include moisture. Due to climate variations, water vapor around the energy storage device 100 may be liquefied to generate dew condensation or the like on the negative electrode terminal 41.

For example, referring to FIG. 5B, a casing is illustrated with the sealing member 45 removed in FIG. 5A. In FIG. 5B, the groove 41b on the stepped portion 41ac of the negative electrode terminal 41 is omitted. In such a case, the swaged projecting portion 44ca and the negative electrode terminal 41 may be in direct contact at a contact portion extending from the surface 41c of the negative electrode terminal 41, through the large diameter portion 41ab and the stepped portion 41ac, until the shaft portion 44c at a base portion of the swaged projecting portion 44ca. Therefore, when the sealing member 45 is provided as illustrated in FIG. 5A, the sealing member 45 is disposed at the contact interface of the swaged projecting portion 44ca and the negative electrode terminal 41, at the above contact portion as indicated by a broken line in FIG. 5B. In this specification and the appended claims, a “contact interface” also indicates a contact interface that is no longer in contact by providing the sealing member 45, between the swaged projecting portion 44ca and the negative electrode terminal 41. Examples of such a contact interface are the inner peripheral surface of the large diameter portion 41ab of the negative electrode terminal 41, the bottom surface of the groove 41b of the negative electrode terminal 41, and a surface of the swaged projecting portion 44ca opposed to the above.

If the sealing member 45 is not provided, liquid permeates into the gap of the above contact portion, that is, the contact interface of the swaged projecting portion 44ca and the negative electrode terminal 41, and the permeated liquid may form a permeation path L1 through the contact interface. Similarly to the contact portion, the permeation path L1 may reach the shaft portion 44c at the base portion of the swaged projecting portion 44ca, from the surface 41c of the negative electrode terminal 41 through the large diameter portion 41ab and the stepped portion 41ac. Then, in the permeation path L1, the liquid may flow in a direction from the surface 41c toward the shaft portion 44c, indicated by a one dotted chain line arrow.

As illustrated in FIGS. 5A and 5B, the sealing member 45 is disposed at an end portion of the contact interface of the swaged projecting portion 44ca and the negative electrode terminal 41, specifically at an entrance to the gap between the swaged projecting portion 44ca and the negative electrode terminal 41. The sealing member 45 is arranged at a most upstream side position in a liquid flow direction along the one dotted chain line arrow in the permeation path L1, to block the permeation path L1 and inhibit intrusion of the liquid into the path. The sealing member 45 blocks the entrance to the permeation path L1, inhibiting electrical connection due to liquid between the swaged projecting portion 44ca and the negative electrode terminal 41 at most of the contact portion, that is, most of the contact interface. The entrance to the permeation path L1 is positioned most distant from the shaft portion 44c in the permeation path L1. Further, the permeation path L1 is bent at the corner portion of the large diameter portion 41ab and the stepped portion 41ac. The sealing member 45 enables effective sealing by being continuously arranged over the bent portion of the permeation path L1 where the liquid becomes difficult to flow and upstream and downstream of the bent portion, and sealing the bent portion and the upstream and downstream of the bent portion in the permeation path L1.

In the sealing member 45, an inner surface of a corner portion formed by the bottom wall portion 45a and the side wall portion 45b, namely a bent inner surface, entirely abuts against the swaged projecting portion 44ca across the bent portion. That is, two adjacent faces facing different directions of the bent inner surface abut against the swaged projecting portion 44ca. This causes the sealing member 45 to effectively inhibit intrusion of liquid into a contact interface of the sealing member 45 and the swaged projecting portion 44ca. Further, in the sealing member 45, an outer surface of the corner portion formed by the bottom wall portion 45a and the side wall portion 45b, namely a bent outer surface, entirely abuts against the negative electrode terminal 41 across the bent portion. That is, two adjacent faces facing different directions of the bent outer surface abut against the negative electrode terminal 41. This causes the sealing member 45 to effectively inhibit intrusion of liquid into the contact interface of the sealing member 45 and the negative electrode terminal 41. Thus, sealing capability of the sealing member 45 is improved by the contact of the plurality of adjacent faces facing different directions in the sealing member 45 with the swaged projecting portion 44ca and the negative electrode terminal 41.

In the sealing member 45, the inner surface of the corner portion formed by the bottom wall portion 45a and the side wall portion 45b, and the outer surface of the corner portion formed by the bottom wall portion 45a and the side wall portion 45b are positioned shifted in the Z-axis direction with respect to the contact interface of the swaged projecting portion 44ca and the stepped portion 41ac, not to be flush. This suppresses permeation of liquid from the contact interface of the swaged projecting portion 44ca and the sealing member 45 to the contact interface of the swaged projecting portion 44ca and the stepped portion 41ac. Similarly, this suppresses permeation of liquid from the contact interface of the negative electrode terminal 41 and the sealing member 45 to the contact interface of the swaged projecting portion 44ca and the stepped portion 41ac.

The sealing member 45 as described above suppresses occurrence of galvanic corrosion caused by liquid between the negative-electrode current collecting member 44 and the negative electrode terminal 41 that are made of mutually dissimilar metals. As described above, for effectively suppressing intrusion of liquid from outside into between constitutional elements made of dissimilar metals, the sealing member 45 is desirably disposed to an interface of constitutional elements positioned outside the container 10. Further, the sealing member 45 is desirably arranged so as to externally straddle and cover outer peripheral edges of the two interfaces of the two constitutional elements made of dissimilar metals. Further, for reducing a gap between the constitutional elements and the sealing member 45 and reliably sealing, sealing by the sealing member 45 is desirably arranged in the axial direction of the shaft portion 44c, which is also the direction of the pressure applied at the time of swaging processing, between the negative-electrode current collecting member 44 and the negative electrode terminal 41, that is, at a portion where they are adjacent. Furthermore, for suppressing conduction between the negative-electrode current collecting member 44 and the negative electrode terminal 41 caused by liquid, the sealing member 45 is desirably interposed between the swaged projecting portion 44ca and the negative electrode terminal 41 even in a direction different from the axial direction of the shaft portion 44c, with the side wall portion 45b or the like.

As described above, the energy storage device 100 according to the present embodiment includes: the negative electrode terminal 41 as a first conductive member; the negative-electrode current collecting member 44, as a second conductive member, that is electrically connected to the electrode assembly 20 and connected to the negative electrode terminal 41, and is arranged passing through the lid body 12 as the wall portion of the container 10; and the sealing member 45 that is nonmetallic and disposed between the negative electrode terminal 41 and the negative-electrode current collecting member 44. Further, the negative electrode terminal 41 and the negative-electrode current collecting member 44 are in direct contact, and the negative electrode terminal 41 and the negative-electrode current collecting member 44 are made of mutually different metal materials. Then, the sealing member 45 is disposed at a contact interface of the negative electrode terminal 41 and the negative-electrode current collecting member 44.

In the configuration described above, the sealing member 45 suppresses intrusion of liquid into between the negative electrode terminal 41 and the negative-electrode current collecting member 44 that are made of different metal materials. This suppresses galvanic corrosion generated by conduction of the negative electrode terminal 41 and the negative-electrode current collecting member 44 through the liquid. This enables suppression of galvanic corrosion with the simple configuration using the sealing member 45.

For example, for suppressing galvanic corrosion between dissimilar metals, at least one of the negative electrode terminal 41 and the negative-electrode current collecting member 44 may be provided with a conductive coating such as nickel plating. In this case, the conductive coating is provided so as to cover at least a contact portion of the negative electrode terminal 41 and the negative-electrode current collecting member 44. While the conductive coating such as nickel plating enables conduction between the negative electrode terminal 41 and the negative-electrode current collecting member 44 by being interposed between the negative electrode terminal 41 and the negative-electrode current collecting member 44, movement of ions is inhibited. However, as in the present embodiment, when the negative electrode terminal 41 is joined with the shaft portion 44c of the negative-electrode current collecting member 44 by swage joining, sliding between the two members may result in peeling of the conductive coating and causing galvanic corrosion. The sealing member 45 in the energy storage device 100 according to the present embodiment can suppress the occurrence of galvanic corrosion caused by the swage joining as described above. Further, the sealing member 45 is pressed by and between the negative electrode terminal 41 and the negative-electrode current collecting member 44 that are joined by the swage joining. This allows the sealing member 45 to enhance the sealing capability between the negative electrode terminal 41 and the negative-electrode current collecting member 44.

In the energy storage device 100 according to the embodiment, the sealing member 45 is disposed at the end portion of the contact interface of the negative electrode terminal 41 and the negative-electrode current collecting member 44. In the above configuration, the sealing member 45 is positioned near the entrance to the contact interface of the negative electrode terminal 41 and the negative-electrode current collecting member 44, that is, near the entrance to the gap between the negative electrode terminal 41 and the negative-electrode current collecting member 44. The sealing member 45 can effectively suppress intrusion of liquid into the contact interface, and inhibit the electrical connection caused by liquid between the negative electrode terminal 41 and the negative-electrode current collecting member 44, in most of the contact interface.

In the energy storage device 100 according to the embodiment, the negative-electrode current collecting member 44 includes the shaft portion 44c passing through the lid body 12, and the fixing portion that fixes the shaft portion 44c to the lid body 12. For example, the fixing portion is constituted by the swaged projecting portion 44ca as a plastic strain part at an end portion of the shaft portion 44c. In the configuration described above, since the shaft portion 44c passing through the lid body 12 is fixed by the swaged projecting portion 44ca, which is a part of the shaft portion 44c, a fixing strength of the shaft portion 44c is enhanced. In the present embodiment, the swaged projecting portion 44ca directly fixes the negative electrode terminal 41 to the lid body 12. This enhances a strength of the negative electrode terminal 41. Furthermore, a processing step for the negative electrode terminal 41 and the shaft portion 44c are unnecessary in the swaging processing for forming the swaged projecting portion 44ca, enabling reduction of cost.

In the energy storage device 100 according to the embodiment, the sealing member 45 is disposed at the portion where the negative electrode terminal 41 and the swaged projecting portion 44ca are adjacent in the axial direction of the shaft portion 44c. In the above-described configuration, for example, when the shaft portion 44c is fixed by being subjected to plastic working such as swaging at an end portion thereof, the swaged projecting portion 44ca fixes the shaft portion 44c to the lid body 12, while axially pressing the negative electrode terminal 41. This reduces the gap among the sealing member 45, the swaged projecting portion 44ca, and the negative electrode terminal 41, providing effective sealing with the sealing member 45.

In the energy storage device 100 according to the embodiment, hardness of the sealing member 45 is lower than hardness of the negative electrode terminal 41 and the negative-electrode current collecting member 44. In the configuration described above, by receiving a pressure between the negative electrode terminal 41 and the negative-electrode current collecting member 44, the sealing member 45 is deformed corresponding to the shape of the contact surface of the negative electrode terminal 41 and the negative-electrode current collecting member 44. This enhances the sealing between the negative electrode terminal 41 and the negative-electrode current collecting member 44.

In the energy storage device 100 according to the embodiment, the sealing member 45 has an L-shaped cross-sectional shape in the radial direction, but the shape of the sealing member 45 is not limited to this. The shape of the sealing member 45 may be any shape as long as capable of liquid-tightly sealing the contact interface of the negative electrode terminal 41 and the negative-electrode current collecting member 44. For example, the cross-sectional of the sealing member 45 may also be I-shaped, S-shaped, or Z-shaped. The sealing member 45 may be disposed, for example, adjacent to the inner peripheral surface of the large diameter portion 41ab of the negative electrode terminal 41, or may be disposed adjacent to the surface of the stepped portion 41ac of the negative electrode terminal 41.

### [Modification 1]

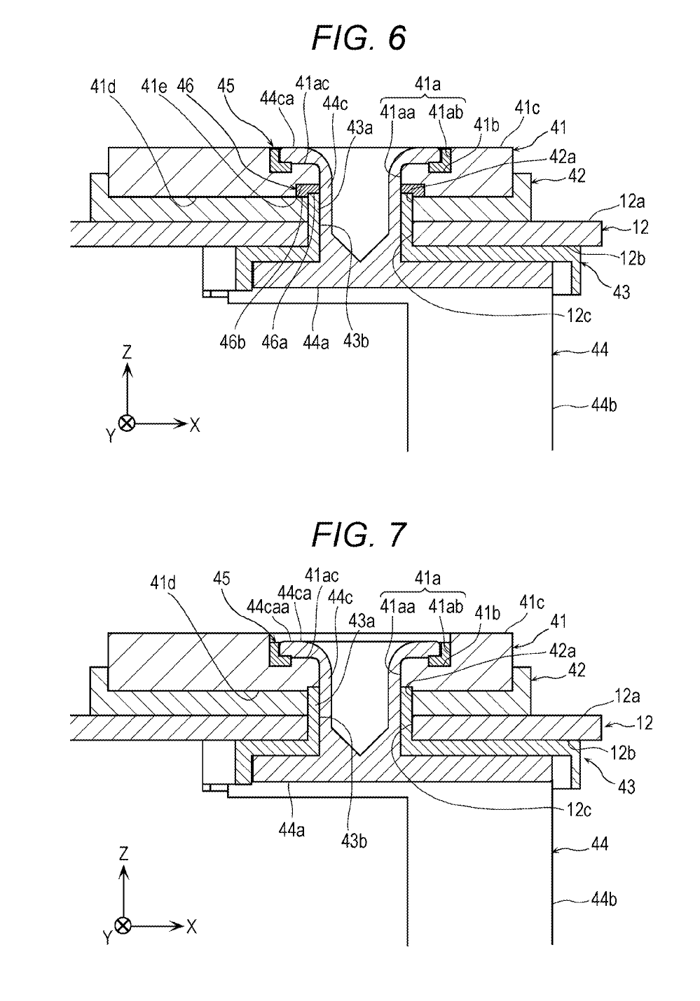

Hereinafter, with reference to FIG. 6, an energy storage device according to Modification 1 of the embodiment will be described. FIG. 6 is a cross-sectional side view illustrating, similarly to FIG. 5A, a configuration of a negative electrode terminal 41 and its periphery in the energy storage device according to Modification 1. It is to be noted that description of a point similar to that in the embodiment will be omitted. The energy storage device according to Modification 1 is different from the energy storage device in the embodiment in that a sealing member 46 is also provided in addition to the sealing member 45, at a portion where the negative electrode terminal 41 and a shaft portion 44c of a negative-electrode current collecting member 44 are adjacent. In this modification, a configuration relating to a negative electrode terminal disposed with a sealing member will be exclusively described.

The energy storage device according to Modification 1 includes a second sealing member 46 having an annular shape between the negative electrode terminal 41 and an upper insulating member 42, and the second sealing member 46 is arranged so as to be externally adjacent to the shaft portion 44c of the negative-electrode current collecting member 44, and to surround an outer periphery of the shaft portion 44c. The second sealing member 46 may be made of a similar material to that of the sealing member (hereinafter also referred to as a first sealing member) 45, or may be made of a material optionally selected from constituent materials of the first sealing member 45 described above.

On a surface 41d of the negative electrode terminal 41, an annular groove 41e is formed adjacent to a small diameter portion 41aa to surround a periphery of the small diameter portion 41aa. The annular groove 41e has a rectangular cross-sectional shape. Similarly to the first sealing member 45, the second sealing member 46 also has an L-shaped cross-sectional shape. The second sealing member 46 is disposed in the annular groove 41e. Here, the second sealing member 46 abuts against an outer peripheral surface of the shaft portion 44c with an inner peripheral surface of its bottom wall portion 46a, abuts against the upper insulating member 42 with an axial end face of its side wall portion 46b, and abuts against the negative electrode terminal 41 with an axial end face of the bottom wall portion 46a and an outer peripheral surface of the side wall portion 46b. Further, a tip end of a tubular portion 43a of a lower insulating member 43 is fitted into a recess formed by the bottom wall portion 46a and the side wall portion 46b around the shaft portion 44c. This causes the second sealing member 46 to seal between the negative electrode terminal 41 and the shaft portion 44c, and to seal between the negative electrode terminal 41 and the upper insulating member 42. Further, the tubular portion 43a extends so as to cross the interfaces of the negative electrode terminal 41 and the upper insulating member 42 in a direction along the XY plane between the negative electrode terminal 41 and the upper insulating member 42. This enables more reliable sealing between the negative electrode terminal 41 and the upper insulating member 42.

In forming the swaged projecting portion 44ca, the negative electrode terminal 41 is pressed against the upper insulating member 42. This causes the second sealing member 46 to be deformed, and to abut against each of the above-mentioned constitutional elements with pressure. This enables more reliable sealing between the second sealing member 46 and each constitutional element.

The second sealing member 46 as described above is provided at an end portion of a contact interface of the small diameter portion 41aa of the negative electrode terminal 41 and the shaft portion 44c of the negative-electrode current collecting member 44, specifically, at an entrance to a gap between the small diameter portion 41aa and the shaft portion 44c. The second sealing member 46 suppresses access of liquid intruding between the negative electrode terminal 41 and the upper insulating member 42, through these interfaces, to the contact interface of the small diameter portion 41aa and the shaft portion 44c. The second sealing member 46 suppresses intrusion of the electrolyte solution in a container 10, flowing along the shaft portion 44c of the negative-electrode current collecting member 44, the tubular portion 43a of the lower insulating member 43, and the like, into the contact interface of the small diameter portion 41aa and the shaft portion 44c. This suppresses occurrence of galvanic corrosion of the negative electrode terminal 41 and the negative-electrode current collecting member 44.

The energy storage device of Modification 1 provides a similar effect to that of the embodiment. Furthermore, in the energy storage device according to Modification 1, the second sealing member 46 is disposed at an end portion of a portion where the negative electrode terminal 41 and the shaft portion 44c of the negative-electrode current collecting member 44 are adjacent. In the above configuration, the second sealing member 46 suppresses intrusion of liquid passing between the negative electrode terminal 41 and the shaft portion 44c. For example, the first sealing member 45 and the second sealing member 46 may be respectively disposed between the swaged projecting portion 44ca and the negative electrode terminal 41, and between the shaft portion 44c and the negative electrode terminal 41. This enables to suppress intrusion of liquid into between the negative electrode terminal 41 and the negative-electrode current collecting member 44, from both of a direction toward inside the container 10 from the swaged projecting portion 44ca, and a direction opposite to this. In addition, since the second sealing member 46 is disposed at the end portion of the contact interface of the negative electrode terminal 41 and the negative-electrode current collecting member 44, it is possible to suppress intrusion of liquid in most of the contact interface.

### [Modification 2]

Hereinafter, with reference to FIG. 7, an energy storage device according to Modification 2 of the embodiment will be described. FIG. 7 is a cross-sectional side view illustrating, similarly to FIG. 5A, a configuration of a negative electrode terminal 41 and its periphery in the energy storage device according to Modification 2. It is to be noted that description of a point similar to that in the embodiment and Modification 1 will be omitted. In the energy storage device according to Modification 2, a swaged projecting portion 44ca of a negative-electrode current collecting member 44 is positioned to be more depressed than a surface 41c of the negative electrode terminal 41, in the energy storage device 100 according to the embodiment. In this modification as well, a configuration relating to a negative electrode terminal disposed with a sealing member will be exclusively described.

Specifically, in the energy storage device according to Modification 2, a projecting end portion 44caa in the Z-axis direction of the swaged projecting portion 44ca of the negative-electrode current collecting member 44 is more depressed than the surface 41c of the negative electrode terminal 41. That is, a projecting end portion 44caa is retreated in the Z-axis direction. This causes the entire swaged projecting portion 44ca to be retreated in the Z-axis direction, that is, retreated in an axial direction of the shaft portion 44c, than the surface 41c. Therefore, when a conductive member such as a bus bar is disposed so as to cross a through hole 41a on the surface 41c of the negative electrode terminal 41 and is connected to the negative electrode terminal 41, the conductive member and the swaged projecting portion 44ca are not in contact with each other. For example, even when the conductive member and the negative-electrode current collecting member 44 are made of dissimilar metals, occurrence of galvanic corrosion between them is suppressed.

Therefore, the energy storage device of Modification 2 provides a similar effect to that of the embodiment. Furthermore, in the energy storage device according to Modification 2, the swaged projecting portion 44ca is positioned to be more depressed than the negative electrode terminal 41 in the axial direction of the shaft portion 44c of the negative-electrode current collecting member 44. In the above configuration, when the conductive member is disposed on the negative electrode terminal 41, conduction between the conductive member and the negative-electrode current collecting member 44 is suppressed.

### [Modification 3]

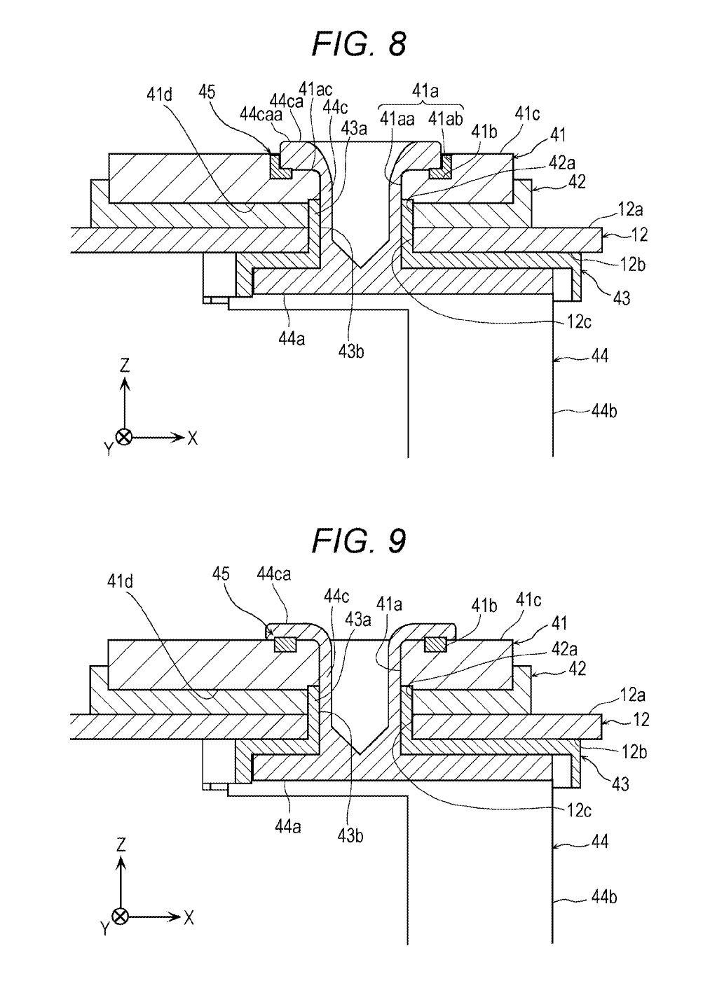

Hereinafter, with reference to FIG. 8, an energy storage device according to Modification 3 of the embodiment will be described. FIG. 8 is a cross-sectional side view illustrating, similarly to FIG. 5A, a configuration of a negative electrode terminal 41 and its periphery in the energy storage device according to Modification 3. It is to be noted that description of a point similar to that in the embodiment and Modifications 1 and 2 will be omitted. In the energy storage device according to Modification 3, a swaged projecting portion 44ca of a negative-electrode current collecting member 44 is positioned to be more protruded than a surface 41c of the negative electrode terminal 41, in the energy storage device 100 according to the embodiment. In this modification as well, a configuration relating to a negative electrode terminal disposed with a sealing member will be exclusively described.

Specifically, in the energy storage device according to Modification 3, a projecting end portion 44caa of the swaged projecting portion 44ca of the negative-electrode current collecting member 44 more protrudes in the Z-axis direction than the surface 41c of the negative electrode terminal 41. This suppresses retention of liquid such as moisture attached to the swaged projecting portion 44ca due to dew condensation or the like, on the swaged projecting portion 44ca. For example, although the retained liquid may intrude between the swaged projecting portion 44ca and a large diameter portion 41ab of the negative electrode terminal 41, this intrusion is suppressed by the above-described configuration.

Therefore, the energy storage device of Modification 3 provides a similar effect to that of the embodiment. Furthermore, in the energy storage device according to Modification 3, the swaged projecting portion 44ca is more protruded than the negative electrode terminal 41 in the axial direction of the shaft portion 44c of the negative-electrode current collecting member 44. In the above-described configuration, retention of liquid on the swaged projecting portion 44ca is suppressed. Although the swaged projecting portion 44ca and the negative electrode terminal 41 may be conducted by liquid retained on the swaged projecting portion 44ca, occurrence of galvanic corrosion caused by this conduction is suppressed.

In the energy storage device according to Modification 3, the swaged projecting portion 44ca more protrudes than the surface 41c of the negative electrode terminal 41 while being positioned in the large diameter portion 41ab of the negative electrode terminal 41. That is, a part of the swaged projecting portion 44ca more protrudes than the surface 41c of the negative electrode terminal 41, but the present invention is not limited to this. For example, as illustrated in FIG. 9, the entire swaged projecting portion 44ca may be more protruded than the surface 41c of the negative electrode terminal 41. FIG. 9 is a cross-sectional side view illustrating, similarly to FIG. 5A, a configuration of the negative electrode terminal and its periphery in the energy storage device according to another aspect of Modification 3. In the example illustrated in FIG. 9, a through hole 41a of the negative electrode terminal 41 is formed by a small diameter portion 41aa without having the large diameter portion 41ab. On the surface 41c of the negative electrode terminal 41, there is formed an annular groove 41b surrounding a periphery of an opening of the through hole 41a. Further, a sealing member 45 having an annular shape is fitted into the groove 41b and protrudes from the surface 41c. The swaged projecting portion 44ca is formed on the surface 41c. The swaged projecting portion 44ca sandwiches the entire sealing member 45, together with the negative electrode terminal 41, and presses the entire sealing member 45 against the negative electrode terminal 41. Although a cross-sectional shape of the sealing member 45 is rectangular in the example of FIG. 9, it may have any shape such as a circle, an ellipse, a polygon, or the like. Such a configuration of the sealing member 45 and the swaged projecting portion 44ca may exhibit a similar effect to that of Modification 3.

### [Modification 4]

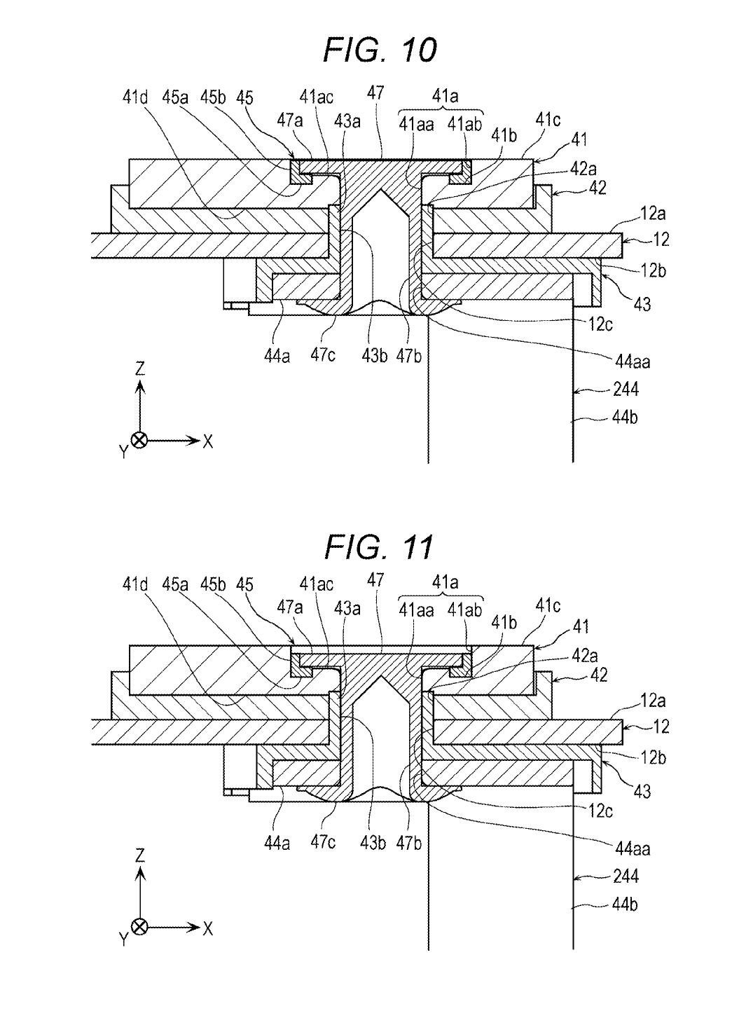

Hereinafter, with reference to FIG. 10, an energy storage device according to Modification 4 of the embodiment will be described. FIG. 10 is a cross-sectional side view illustrating, similarly to FIG. 5A, a configuration of a negative electrode terminal 41 and its periphery in the energy storage device according to Modification 4. It is to be noted that description of a point similar to that in the embodiment and Modifications 1 to 3 will be omitted. In the energy storage device according to Modification 4, a shaft portion 44c of a negative-electrode current collecting member 44 is configured to be a member separate from a base 44a, in the energy storage device 100 according to the embodiment. In this modification as well, a configuration relating to a negative electrode terminal disposed with a sealing member will be exclusively described.

In the energy storage device according to Modification 4, a negative-electrode current collecting member 244 includes the base 44a and a leg portion 44b, similarly to the negative-electrode current collecting member 44 according to the embodiment, but does not include a shaft portion 44c. The energy storage device according to Modification 4 includes a shaft member 47 having a cylindrical shape with a flange, and the shaft member 47 extends passing through the negative electrode terminal 41, an upper insulating member 42, a lid body 12, a lower insulating member 43, and the base 44a. The shaft member 47 integrally includes a shaft body portion 47b having a cylindrical shape, and a flange portion 47a which has a disk shape and extends to radially expand from one axial end portion of the shaft body portion 47b. The shaft member 47 is disposed with the flange portion 47a positioned on a stepped portion 41ac in a large diameter portion 41ab of the negative electrode terminal 41, and with the shaft body portion 47b passing through from the negative electrode terminal 41 to the base 44a. The flange portion 47a extends to a top of a sealing member 45, and a peripheral edge of the flange portion 47a is fitted into a recess formed inside a bottom wall portion 45a and a side wall portion 45b of the sealing member 45. The shaft member 47 as used herein is an example of a second conductive member.

A tip portion of the shaft body portion 47b protruding from the base 44a is subjected to swaging processing, and a swaged projecting portion 47c is formed on the base 44a. Therefore, the shaft member 47 holds the negative electrode terminal 41, the upper insulating member 42, the lid body 12, the lower insulating member 43, and the base 44a, with the flange portion 47a and the swaged projecting portion 47c, while pressing inward in an axial direction. The bottom wall portion 45a axially pressed by the flange portion 47a effectively seals between the flange portion 47a and the bottom wall portion 45a, and between the bottom wall portion 45a and the negative electrode terminal 41. Therefore, the energy storage device of Modification 4 provides a similar effect to that of the embodiment.

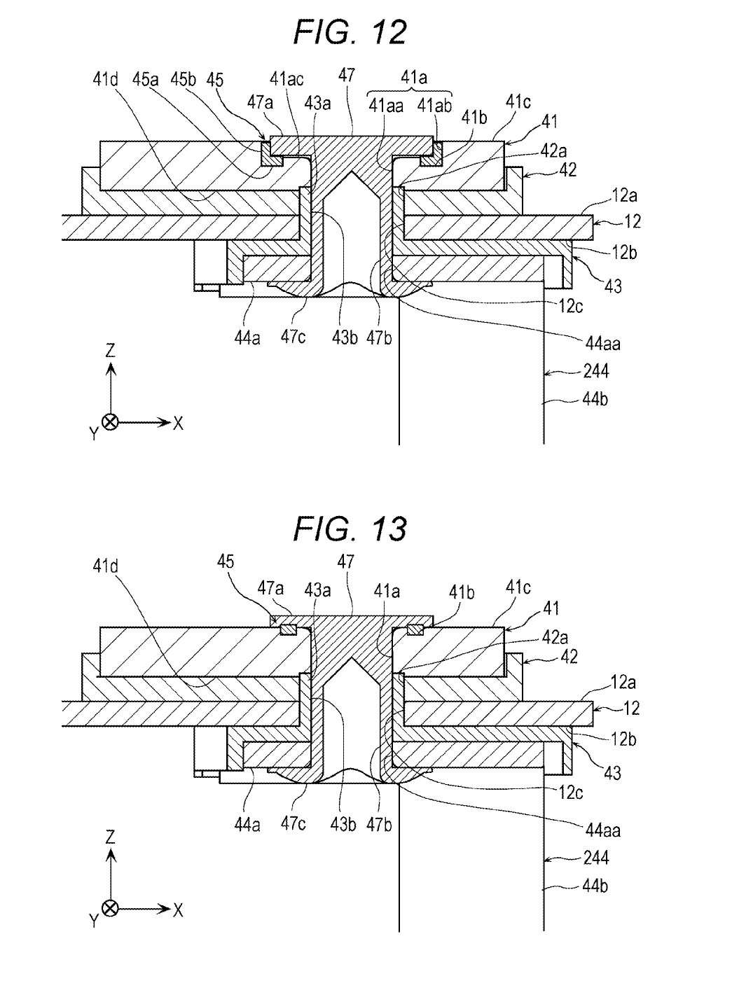

In the energy storage device according to Modification 4, as illustrated in FIGS. 11 to 13, the flange portion 47a of the shaft member 47 may have the similar configuration to that of the swaged projecting portion 44ca described in Modifications 2 and 3. FIGS. 11 to 13 are cross-sectional side views illustrating, similarly to FIG. 5A, a configuration of the negative electrode terminal and its periphery in the energy storage device according to another aspect of Modification 4. For example, the flange portion 47a of the shaft member 47 illustrated in FIG. 11 is positioned to be more depressed than a surface 41c of the negative electrode terminal 41 in the Z-axis direction, which is an axial direction of the shaft body portion 47b of the shaft member 47, similarly to the swaged projecting portion 44ca of Modification 2 illustrated in FIG. 7. The flange portion 47a of the shaft member 47 illustrated in FIG. 12 is more protruded than the surface 41c of the negative electrode terminal 41 in the axial direction of the shaft body portion 47b, similarly to the swaged projecting portion 44ca of Modification 3 illustrated in FIG. 8. The flange portion 47a of the shaft member 47 illustrated in FIG. 13 is positioned on the surface 41c of the negative electrode terminal 41, sandwiches the entire sealing member 45 disposed in a groove 41b of the surface 41c, together with the negative electrode terminal 41, and presses the entire sealing member 45 against the negative electrode terminal 41, similarly to the swaged projecting portion 44ca of another aspect of Modification 3 illustrated in FIG. 9. The configuration of the flange portion 47a and the sealing member 45 illustrated in FIGS. 11 to 13 may exhibit similar effects to those of the configurations of the swaged projecting portion 44ca and the sealing member 45 in Modifications 2 and 3.

### [Modification 5]

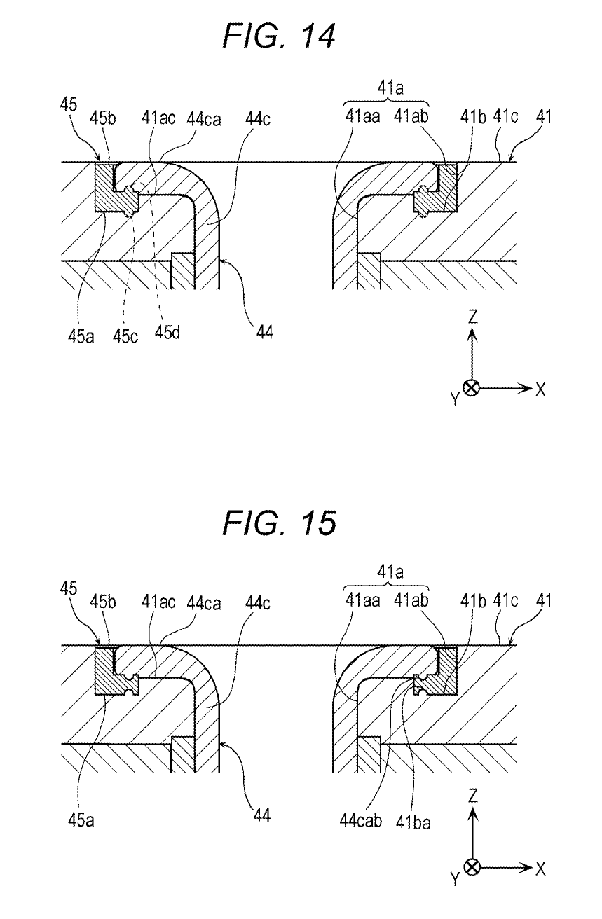

Hereinafter, with reference to FIG. 14, an energy storage device according to Modification 5 of the embodiment will be described. FIG. 14 is a cross-sectional side view illustrating, in a similar cross section to that in FIG. 5A, a configuration of a negative electrode terminal 41 and sealing member 45 in the energy storage device according to Modification 5. It is to be noted that description of a point similar to that in the embodiment and Modifications 1 to 4 will be omitted. The energy storage device according to Modification 5 has a configuration in which a protrusion is formed on a bottom wall portion of the sealing member, in the energy storage device 100 according to the embodiment. In this modification as well, a configuration relating to a negative electrode terminal disposed with a sealing member will be exclusively described.

In the energy storage device according to Modification 5, the sealing member 45 integrally includes convex parts 45c and 45d, which are annular protrusions, on both surfaces of the bottom wall portion 45a. The convex part 45c is disposed on a surface of the bottom wall portion 45a opposed to a bottom portion of a groove 41b of a stepped portion 41ac in a through hole 41a in the Z-axis direction, while the convex part 45d is disposed on a surface opposite to the above surface, in the bottom wall portion 45a. The convex parts 45c and 45d extend along a circumferential direction of the bottom wall portion 45a having an annular shape.

A swaged projecting portion 44ca formed by swaging processing, of a negative-electrode current collecting member 44, presses the bottom wall portion 45a of the sealing member 45 against the negative electrode terminal 41 in the Z-axis direction. Here, the convex parts 45c and 45d protrude respectively toward the negative electrode terminal 41 and the swaged projecting portion 44ca. Further, the convex parts 45c and 45d respectively come into contact with the negative electrode terminal 41 and the swaged projecting portion 44ca, at a higher pressure than other portions of the bottom wall portion 45a. Therefore, the convex parts 45c and 45d effectively seal between the bottom wall portion 45a and the negative electrode terminal 41, and between the bottom wall portion 45a and the swaged projecting portion 44ca, respectively.

Therefore, the energy storage device of Modification 5 provides a similar effect to that of the embodiment. Furthermore, in the energy storage device according to Modification 5, the sealing member 45 includes the convex parts 45c and 45d that protrude toward the negative electrode terminal 41 and the negative-electrode current collecting member 44. In the above configuration, the sealing member 45 can increase a contact pressure of the convex parts 45c and 45d by bringing the convex parts 45c and 45d into respectively contact with the negative electrode terminal 41 and the negative-electrode current collecting member 44. This allows the sealing member 45 to enhance the sealing between the negative electrode terminal 41 and the negative-electrode current collecting member 44. It is to be noted that the sealing member 45 may be provided with either one of the convex parts 45c and 45d alone. The convex parts 45c and 45d may constitute a separate member from the sealing member 45, and may be attached to the sealing member 45. Further, each of the convex parts 45c and 45d may be divided into a plurality of parts without forming a continuous ring. In this case, the pressed convex parts 45c and 45d each are desirably deformed to close a gap between the plurality of parts thereof.

### [Modification 6]

Hereinafter, with reference to FIG. 15, an energy storage device according to Modification 6 of the embodiment will be described. FIG. 15 is a cross-sectional side view illustrating, similarly to FIG. 14, a configuration of a negative electrode terminal 41 and sealing member in the energy storage device according to Modification 6. It is to be noted that description of a point similar to that in the embodiment and Modifications 1 to 5 will be omitted. The energy storage device according to Modification 6 has a configuration in which a convex part is formed on the negative electrode terminal 41 and a swaged projecting portion 44ca of a negative-electrode current collecting member 44, in the energy storage device 100 according to the embodiment. In this modification as well, a configuration relating to a negative electrode terminal disposed with a sealing member will be exclusively described.

In the energy storage device according to Modification 6, the negative electrode terminal 41 integrally includes a convex part 41ba, which is an annular convex part, at a bottom portion of a groove 41b of a stepped portion 41ac in a through hole 41a. The convex part 41ba extends along a circumferential direction of the groove 41b. The negative-electrode current collecting member 44 integrally includes a convex part 44cab, which is an annular convex part, at a position corresponding to the swaged projecting portion 44ca of a shaft portion 44c. The convex part 44cab extends in a circumferential direction along an outer peripheral surface of the shaft portion 44c, and surrounds the shaft portion 44c.

The swaged projecting portion 44ca formed by swaging processing, of the negative-electrode current collecting member 44, presses a bottom wall portion 45a of the sealing member 45 against the negative electrode terminal 41 in the Z-axis direction. Here, the convex part 44cab positioned at the swaged projecting portion 44ca is positioned opposed to the bottom wall portion 45a, and protrudes toward the bottom wall portion 45a. The convex part 41ba of the negative electrode terminal 41 is positioned opposed to the bottom wall portion 45a, and protrudes toward the bottom wall portion 45a. Further, the convex parts 41ba and 44cab each come into contact with the bottom wall portion 45a at a higher pressure than other portions of the negative electrode terminal 41 and the swaged projecting portion 44ca, providing effective sealing between the bottom wall portion 45a and the convex parts 41ba and 44cab.

Therefore, the energy storage device of Modification 6 provides a similar effect to that of the embodiment. Furthermore, in the energy storage device according to Modification 6, the negative electrode terminal 41 and the negative-electrode current collecting member 44 include the convex parts 41ba and 44cab protruding toward the sealing member 45. In the above-described configuration, contact between the convex parts 41ba and 44cab and the sealing member 45 can increase a mutual contact pressure. This enables enhancement of sealing between the sealing member 45, and the negative electrode terminal 41 and the negative-electrode current collecting member 44 that have the convex parts 41ba and 44cab. It is to be noted that either one of the convex parts 41ba and 44cab alone may be provided. The convex parts 41ba and 44cab may constitute a separate member from the negative electrode terminal 41 and the negative-electrode current collecting member 44, respectively, and may be attached to the negative electrode terminal 41 and the negative-electrode current collecting member 44. Further, each of the convex parts 41ba and 44cab may be divided into a plurality of parts without forming a continuous ring. In this case, the sealing member 45 pressed by the convex parts 41ba and 44cab is desirably deformed to close a gap between the plurality of parts of each of the convex parts 41ba and 44cab.

### [Other Modifications]

Although the energy storage device according to the embodiment and the modifications of the present invention has been described above, the present invention is not limited to the above embodiment and modifications. That is, the embodiment and the modifications disclosed herein are examples in all respects and are not to be considered to be restrictive. The scope of the present invention is defined not by the description above but by the claims, and it is intended to include all variations within the meaning and scope equivalent to the claims.

In the energy storage device according to the embodiment and the modifications, the sealing member 45 is a member having a certain thickness, for example, a thickness larger than the depth of the groove 41b of the through hole 41a of the negative electrode terminal 41, but the present invention is not limited to this. The sealing member may be a thin member such as a membrane or a film. In this case, for example, the groove 41b of the negative electrode terminal 41 may be or may not be provided.

In the energy storage device according to the embodiment and the modifications, for example, the sealing member 45 extends from the bottom portion of the groove 41b to the inner peripheral surface of the large diameter portion 41ab in the through hole 41a of the negative electrode terminal 41, but the present invention is not limited to this. For example, the sealing member may be disposed exclusively on either one of the bottom portion of the groove 41b and the inner peripheral surface of the large diameter portion 41ab. When the sealing member is provided exclusively on the inner peripheral surface of the large diameter portion 41ab, the sealing member may be press-fitted between the inner peripheral surface of the large diameter portion 41ab and the swaged projecting portion 44ca, after forming the swaged projecting portion 44ca.

In the energy storage device according to the embodiment and the modifications, the positive-electrode current collecting member and the negative-electrode current collecting member each have the base abutting against the lower insulating member, but the present invention is not limited to this. The shaft portions of the positive-electrode current collecting member and the negative-electrode current collecting member may be configured to be directly connected to the leg portions.

In the energy storage device according to the embodiment and the modifications, the positive-electrode current collecting member and the negative-electrode current collecting member each have the shaft portion passing through the upper insulating member, the lid body, and the lower insulating member, but the present invention is not limited to this. The shaft portion may be configured as a part of the positive electrode terminal or the negative electrode terminal.

The energy storage device according to the embodiment and the modifications includes the electrode assembly 20 disposed with the winding axis A oriented in the direction along the lid body 12 of the container 10. However, the energy storage device may include an electrode assembly disposed with the winding axis A oriented in a direction substantially perpendicular to the lid body 12.

In the energy storage device according to the embodiment and the modifications, the positive-electrode current collecting member and negative-electrode current collecting member are directly connected to the end portion in the winding axis A direction of the electrode assembly 20, but the present invention is not limited to this. The electrode assembly may have a positive electrode tab and a negative electrode tab that are projecting pieces protruding from the positive electrode plate and the negative electrode plate at an end portion in the winding axis A direction, and the positive electrode tab and the negative electrode tab may be respectively connected to the positive-electrode current collecting member and the negative-electrode current collecting member.

In the energy storage device according to the embodiment and the modifications, the electrode assembly 20 is a wound type electrode assembly formed by winding the positive electrode plate, the negative electrode plate, and the separator all together, but the present invention is not limited to this. The electrode assembly may be a stacked type electrode assembly formed by stacking many positive electrode plates, negative electrode plates, and separators, or may also be a Z-type electrode assembly formed by multiply bending one set of or two or more sets of stacked positive electrode plates, negative electrode plates, and separators.

In the energy storage device according to the embodiment and the modifications, one electrode assembly 20 is provided in the container 10, but the energy storage device may have a configuration including two or more electrode assemblies.

Further, configurations established by optionally combining the embodiment and the modifications are also included within the scope of the present invention. Further, the present invention may also include, in addition to the above-described energy storage device, an energy storage apparatus including one or more energy storage devices. For example, the energy storage apparatus can be realized as an apparatus including a plurality of energy storage devices 100. The energy storage apparatus includes a plurality of energy storage units arranged side by side, and each energy storage unit is configured by, for example, a plurality of energy storage devices 100 arranged in a line and electrically connected to each other. According to the above configuration, the plurality of energy storage devices 100 are used as one unit, and a quantity and arrangement of the energy storage units can be selected corresponding to an electric capacity required for the energy storage apparatus, a shape and dimensions of the energy storage apparatus, and the like. The energy storage apparatus including the plurality of energy storage devices 100 and having high output can also be mounted as a power source for a vehicle such as an electric vehicle (EV), a hybrid electric vehicle (HEV), a plug-in hybrid electric vehicle (PHEV), and an automated guided vehicle (AGV).

The present invention can be applied to an energy storage device and the like, such as a lithium ion secondary battery.

What is claimed is:

1. An energy storage device comprising:
an electrode assembly;
a container that includes a wall portion and accommodates the electrode assembly;
a first conductive member;
a second conductive member electrically connected to the electrode assembly and connected to the first conductive member, the second conductive member being arranged to pass through the wall portion; and
a sealing member that is nonmetallic and disposed between the first conductive member and the second conductive member,
wherein the first conductive member and the second conductive member are in direct contact;
the first conductive member and the second conductive member are made of mutually different metal materials; and
the sealing member is disposed at a contact interface of the first conductive member and the second conductive member.

2. The energy storage device according to claim 1, wherein the sealing member is disposed at an end portion of the contact interface of the first conductive member and the second conductive member.

3. The energy storage device according to claim 1, wherein the second conductive member includes a shaft portion passing through the wall portion, and a fixing portion that fixes the shaft portion to the wall portion.

4. The energy storage device according to claim 3, wherein the second conductive member includes a plastic strain part at an end portion of the shaft portion, and the fixing portion is constituted by the plastic strain part.

5. The energy storage device according to claim 3, wherein the sealing member includes a first sealing member disposed at a portion where the first conductive member and the fixing portion are adjacent in an axial direction of the shaft portion.

6. The energy storage device according to claim 3, wherein the sealing member includes a second sealing member disposed at a portion where the first conductive member and the shaft portion are adjacent.

7. The energy storage device according to claim 3, wherein the fixing portion more protrudes than the first conductive member in the axial direction of the shaft portion.

8. The energy storage device according to claim 3, wherein the fixing portion is positioned to be more depressed than the first conductive member in the axial direction of the shaft portion.

9. The energy storage device according to claim 1, wherein hardness of the sealing member is lower than hardness of the first conductive member and hardness of the second conductive member.

10. The energy storage device according to claim 1, wherein the sealing member includes a convex part protruding toward at least one of the first conductive member and the second conductive member.

11. The energy storage device according to claim 1, wherein at least one of the first conductive member and the second conductive member includes a convex part protruding toward the sealing member.
